(19) United States
(12) Patent Application Publication
(10) Pub. No.: US 2006/0169120 A1
(43) Pub. Date: Aug. 3, 2006

(54) Serrated utility knife blade

(76) Inventor: Donald Smith, South Lake Tahoe, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/344,052

(22) Filed: Jan. 30, 2006

Related U.S. Application Data
(60) Provisional application No. 60/648,378, filed on Jan. 28, 2005.

(51) Int. Cl. B23D 57/00; B27B 13/02

(52) U.S. Cl. 83/835

(57) ABSTRACT

A utility razor blade having a serrated edge. A bottom edge of the razor blade has a left portion and a right portion having a razor edge. A middle portion between the left portion and the right portion is serrated.

### CLAIM OF PRIORITY

This application claims priority of U.S. Ser. No. 60/648,378 filed on Jan. 28, 2005, which is incorporated by reference.

### FIELD OF THE INVENTION

The present invention relates to razor blades, and more particularly, to a razor blade with a serrated edge.

### BACKGROUND OF THE RELATED ART

There have been a significant number of designs for blades and the like. The patent literature is complete with razor and knife designs. U.S. Pat. No. 6,802,127, to Thomaschewski, has an issue date of Oct. 12, 2004. The patent is directed towards a cutting knife for a cutting tool for cutting through adhesive beads on glass panes of vehicles comprises an attachment part and a cutting part. The attachment part, on a first end thereof, is provided with a receiving opening for attachment to an oscillating drive and tapers toward a second end. The cutting part extends at an angle with respect to a plane in which the flat attachment part extends. The cutting part has two lateral edges that join each other at the outer end of the cutting part, at least one of the lateral edges of the cutting part being shaped as a corrugated or serrated cutting edge.

U.S. Pat. No. 4,823,467, to Campbell, has an issue date of Apr. 25, 1989. The patent is directed towards a serrated-edge knife, the blade of which is provided on one side with a plurality of scallops and on its other side with a plurality of closely spaced serrations, the scallops intersecting the serrations to produce a fine saw-like edge substantially centrally of the thickness of the blade.

U.S. Pat. No. D409,269, to Carson, has an issue date of May 4, 1999. The design patent is directed toward an ornamental design for a fixed blade knife.

There are also several blade designs. The Heavy Duty Utility Blade, manufactured by Stanley Co., represents the common trapezoidal straight edged blade.

The X-Acto #13, #27, and #227 Serrated Blade, manufactured by Hunt Corp., are serrated knife blade inserts for X-Acto hobby knives and tools.

While there have been a large number of prior art systems directed to knives and blades, there has been no system combining a razor and a serrated blade.

### SUMMARY OF THE INVENTION

It is an aspect of the present invention to provide a serrated utility knife blade.

The above aspects can also be obtained by an apparatus that includes a utility razor blade having a bottom edge on a bottom of the razor blade and bottom edge comprising of a left layer portion and a right portion having a razor edge; and a middle portion between the left portion and the right portion having a serrated edge.

The present invention is directed, in one embodiment, to a razor blade, comprising of a utility razor blade having a bottom cutting edge comprising a first portion and a second portion each comprising a razor edge; and a third portion proximate to the first portion and the second portion and having a serrated edge.

In yet a further embodiment, the present invention is directed to a razor blade as recited in claim 1, wherein the serrations are only on one end.

In still a further embodiment, the present invention is directed to a razor blade, comprising a trapezoidally shaped utility razor blade having a bottom cutting edge comprising a left portion and a right portion each comprising a razor edge; and a middle portion between the left portion and the right portion having a serrated razor edge.

In yet still a further embodiment, the present invention is directed to a razor blade, comprising a shaped steel utility razor blade having a bottom cutting edge comprising a left portion and a right portion each comprising a razor edge; a middle portion between the left portion and the right portion having a serrated edge; and means for attaching a blade to a handle.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing illustrating a serrated utility knife blade, according to an embodiment of the present invention.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

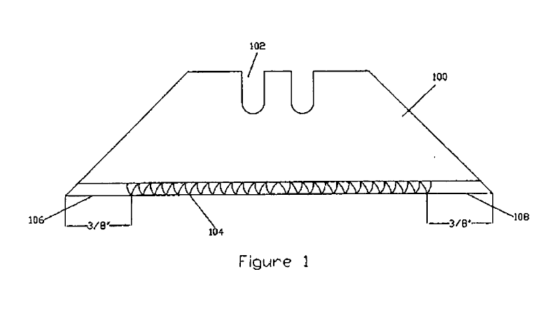

FIG. 1 is a drawing illustrating a serrated utility knife blade 100, according to an embodiment of the present invention. In one embodiment, the blade is trapezoidally shaped. A razor blade 100 contains a top 102. The top has two u shaped recesses 103 which can slide on a grip (not pictured) of an external part.

The razor blade 100 has a bottom surface which includes a serrated edge 104. The bottom also has a left portion 106 which is not serrated. The bottom also has a right portion 108 which is not serrated.

A length of the left portion 106 can be ⅜ of an inch, and a length of the right portion can be ⅜ of an inch.

The razor blade as described can be useful for many tasks, such as slicing food or cutting roofing material, wood, sheet rock, etc. The serrated edge can be an effective cutter while making a sliding motion with the razor blade. The blade can thus be inserted in a standard utility knife holder.

The blade of the present invention can comprise of a plurality of components, including steel, titanium, aluminum or polymer. The many features and advantages of the invention are apparent from the detailed specification and, thus, it is intended by the appended claims to cover all such features and advantages of the invention that fall within the true spirit and scope of the invention.

Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A razor blade, comprising:
A utility razor blade having a bottom cutting edge comprising:
a first portion and a second portion each comprising a razor edge; and
a third portion proximate to the first portion and the second portion and having a serrated edge.

2. A razor blade as recited in claim 1, wherein the first portion and second portions are approximately ⅜ inches long.

3. A razor blade as recited in claim 1, wherein the serrations are only on one end.

4. A razor blade, comprising:
a trapezoidally shaped utility razor blade having a bottom cutting edge comprising
a left portion and a right portion each comprising a razor edge; and
a middle portion between the left portion and the right portion having a serrated razor edge.

5. A razor blade, comprising:
a shaped steel utility razor blade having a bottom cutting edge comprising:
a left portion and a right portion each comprising a razor edge;
a middle portion between the left portion and the right portion having a serrated edge; and
means for attaching a blade to a handle.
